(19) United States
(12) Patent Application Publication
(10) Pub. No.: US 2014/0181105 A1
(43) Pub. Date: Jun. 26, 2014

(54) VEHICLE POINT AND SELECT

(71) Applicant: Continental Automotive Systems, Inc., (US)

(72) Inventors: Orlando Javier Avila, Chicago, IL (US); Michael Young-kuei Pan, West Dundee, IL (US); Vincent David Skibicki, JR., Round Lake, IL (US)

(73) Assignee: CONTINENTAL AUTOMOTIVE SYSTEMS, INC., Auburn Hills, MI (US)

(21) Appl. No.: 13/726,079

(22) Filed: Dec. 22, 2012

(51) Int. Cl. G06F 17/30

(52) U.S. Cl. CPC G06F 17/30241
USPC 707/736

(57) ABSTRACT

A point and select method, apparatus and system are disclosed. The method comprises capturing a pointing direction of a user, obtaining geopositioning information, communicating the pointing direction and the geopositioning information to a database, the database configured to analyze the pointing direction and the geopositioning information to arrive at at least one of context dependent options and context dependent information, receiving and communicating to the user the at least one of context dependent options and context dependent information, and upon a user requesting one of the at least one context dependent option, receiving and fulfilling the requested option.

### BRIEF DESCRIPTION OF THE DRAWINGS

For a more complete understanding of the disclosure, reference should be made to the following detailed description and accompanying drawings wherein:

FIG. 1 comprises a schematic view of an exemplary system interface;

FIG. 2 comprises a schematic view of exemplary use scenarios;

FIG. 3 comprises a schematic view of an exemplary system.

Skilled artisans will appreciate that elements in the figures are illustrated for simplicity and clarity and have not necessarily been drawn to scale. For example, the size dimensions and/or relative positioning of some of the elements in the figures may be exaggerated relative to other elements to help to improve understanding of various aspects of the present invention. Also, common but well-understood elements that are useful or necessary in a commercially feasible embodiment are often not depicted in order to facilitate a less obstructed view of these various aspects of the present invention. Furthermore, it will be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

With the advancement of head unit/navigation technology, receiving instant information in the vehicle has become easier. Unfortunately, the flood of available information has also become an increasing distraction and safety issue for drivers.

Some of the distractions modern drivers experience may experience include: inputting information into the Navigation system; searching an address in mobile device; and looking for general information of a nearby business, e.g. phone number, hours of operation.

Accordingly it is desirable to provide a simple and safe input method to the infotainment system or passed through a smart phone without requiring a physical interface.

Using a kinetic point and select system with integrated motion detection and a geopositioning, users are able to point at a location or object outside the vehicle and obtain the information that they desire. Some of the possible uses of such a system include: finding an exact address; finding a phone number of a business; obtaining reservation and wait time information for restaurants; checking Facebook status or “check in” update; saving a location as a point of interest in the navigation system; input information about landmarks or businesses; searching for deals and coupons of local stores; initiating communication between vehicles.

While current systems often involve the use of a touch screen or physical button, in some examples of a kinetic point and select system no physical button is needed. In an aspect, the system and method uses a free air environment to input surrounding selections.

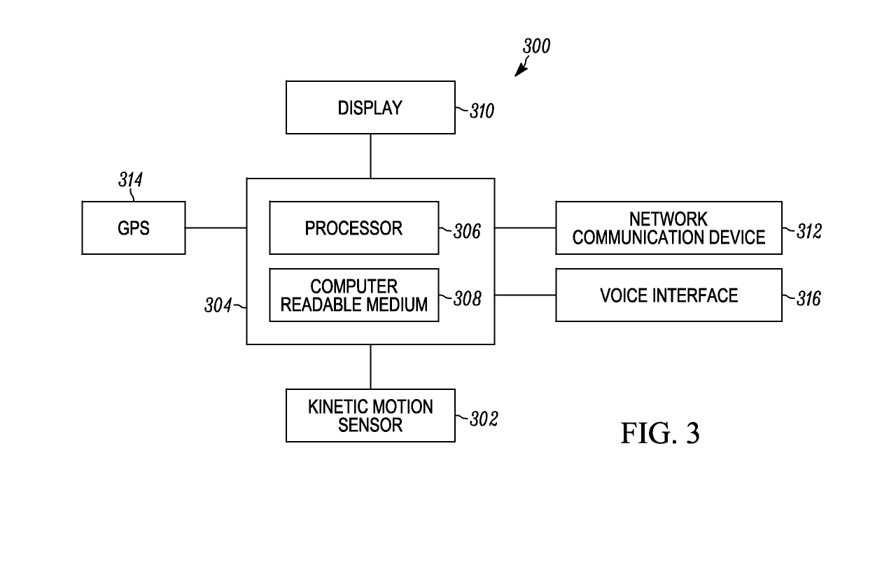

With reference to FIG. 3, in an example the system 300 comprises a controller 304 configured to provide infotainment services, at least one kinetic motion sensor 302, a network communication device 312, a geopositioning system 314, a voice interface 316, and at least at least one display 310. The controller comprises at least one processor 306 and computer readable medium 308, the computer readable medium 308 not being a transient signal, the medium configured to store data or instructions executable by at least one processor for providing infotainment services.

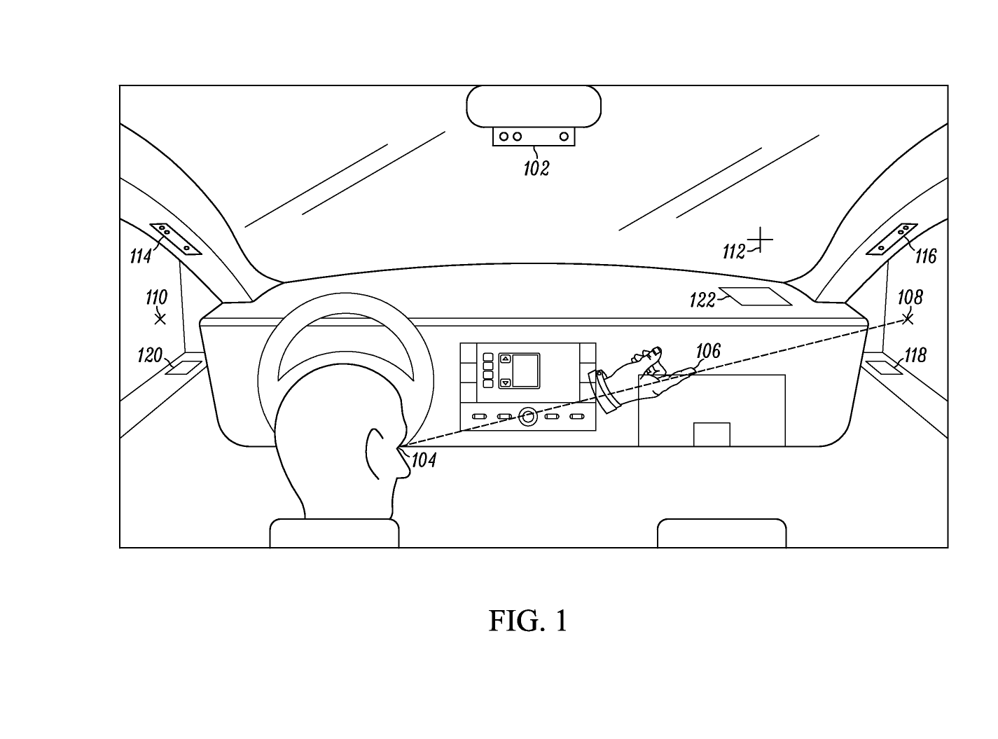

With reference to FIG. 1 when the point and select system is activated, the user points at three set points 108, 110 and 112 within the vehicle in order to calibrate the system. Based on the locations of the user's hand 106 while pointing at the three set points 108, 110 and 112, the system learns the location of the user's eyes 104. In an aspect the calibration points are displayed by via at least one display 118, 122, or 120 to the user. In another aspect the display points are not displayed by any of the displays 118, 122, or 120, for example the points are statically marked on the interior of the cabin.

With continued reference to FIG. 1, after the system is calibrated, when a user finds a point of interest, the user points in the direction of a point of interest. The pointing direction is captured by the kinetic sensor 102, 114, or 116 and communicated to the controller. In an example, the controller in turn communicates via the network communication device the pointing direction information along with geopositioning information obtained from the geopositioning system 314 to a database. The database analyzes the pointing direction and the geopositioning information to arrive at a set of context dependent options for the user and communicates those options back to the controller via the network communication device. The system then communicates the set of options either via the voice interface or via at least one display 118, 122, or 120 to the user. In another example the database is local, for example within the vehicle. In this example, the controller communicates with the database, and vice versus, internally rather than via the network access devices. Nonetheless, in some examples, multiple databases including combinations of local and network accessible databases are contemplated.

In one example the system provides three points of interest that are relative to the direction of the pointing. In this example, the user then chooses one of the three points of interest by pointing in a particular direction, making a gesture, through voice recognition or otherwise. In this example, after one point of interest is chosen the system provides a list of choices to the user that may be relevant to the chosen point. Some of the exemplary choices may include: placing a telephone call to the location; listing of the hours of operation; listing of any relevant coupons; site information, e.g. building history; Sale information e.g. mobile house hunting; Facebook updates; or otherwise. The user then chooses a particular option using one of the methods described above, or otherwise. The system then fulfills request identified by the chosen option, for example the system provides the information requested either via the voice interface or via at least one display 118, 122, or 120 to the user, initiates a chat session, updates the Facebook page, or otherwise.

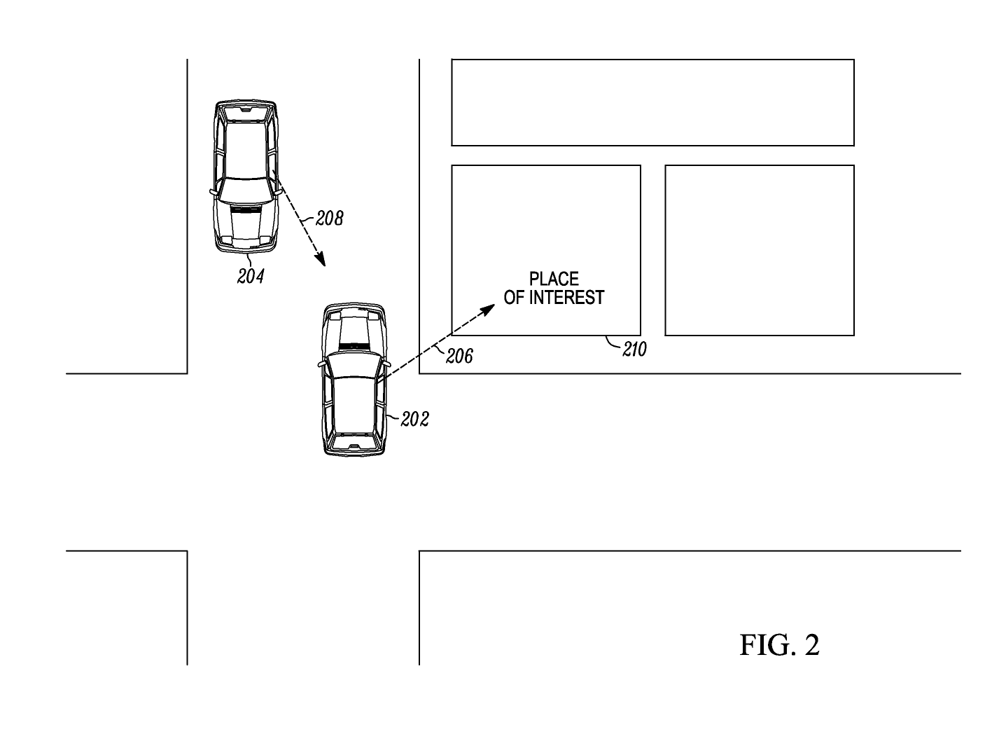

With reference to FIG. 2, in one aspect, the system ascertains the geopositioning information of the vehicle 202 and the direction of pointing 206, to provide the user with options relevant to a point of interest 210.

With continued reference to FIG. 2, in another aspect, the system ascertains the geopositioning information of the vehicle 204 and the direction of pointing 208 to initiate communications with vehicle 202.

In an example, the system recognizes predetermined gestures or learns and recognizes new gestures that indicate a set of actions for the vehicle, for example an emergency stop. In an example at least one display 118, 122, or 120 is a heads up display. In an aspect the heads up display can highlight points of interest for selection, for example analogously to displaying calibration points 108, 110 and 112.

Those skilled in the art will recognize that a wide variety of modifications, alterations, and combinations can be made with respect to the above described embodiments without departing from the spirit and scope of the invention, and that such modifications, alterations, and combinations are to be viewed as being within the scope of the invention. Further, those skilled in the art will recognize that the approaches described herein may also be used in other human machine interface systems, including other point and select systems, or otherwise.

What is claimed is:

1. A point and select apparatus comprising:
a controller configured to communicatively couple to a kinetic motion sensor;
the motion sensor configured to capture a pointing direction of a user;
the controller configured to communicate the pointing direction to a first database;
the first database configured to analyze the pointing direction to arrive at a set of at least one of context dependent options and context dependent information.

2. The apparatus as recited in claim 1, wherein the controller is configured to communicate to the first database via a network communication device.

3. The apparatus as recited in claim 1, wherein the controller is configured to communicate to the first database internally.

4. The apparatus as recited in claim 1, wherein the controller is further configured to obtain geopositioning information and communicate the geopositioning information to the first database.

5. The apparatus as recited in claim 4, wherein the first database is further configured to analyze the geopositioning information.

6. The apparatus as recited in claim 5, wherein the pointing direction and the geopositioning information are indicative of at least one point of interest.

7. The apparatus as recited in claim 6, wherein the at least one point of interest provides a context for the at least one of context dependent options and context dependent information.

8. The apparatus as recited in claim 7, wherein the controller is further configured to receive and communicate to the user the at least one of context dependent options and context dependent information.

9. The apparatus as recited in claim 8, wherein the at least one of context dependent options and context dependent information is an at least one context dependent option, and wherein the controller is further configured to, upon the user requesting one of the at least one context dependent option, receive and fulfill the requested option.

10. The apparatus as recited in claim 9, wherein the requested option is to provide information related to the at least one point of interest.

11. The apparatus as recited in claim 9, wherein the requested option is to update a second database with information related to the at least one point of interest.

12. The apparatus as recited in claim 9, wherein the requested option is to establish communication with the at least one point of interest.

13. The apparatus as recited in claim 1, further comprising a geopositioning system configured to provide geopositioning information.

14. A point and select infotainment system comprising:
a controller and a kinetic motion sensor mounted in a vehicle;
the controller communicatively coupled to the kinetic motion sensor;
the motion sensor configured to capture a pointing direction of a user;
the controller further configured to obtain geopositioning information;
the controller further configured to communicate the pointing direction and the geopositioning information to a first database;
the first database configured to analyze the pointing direction and the geopositioning information to arrive at a set of at least one of context dependent options and context dependent information;
wherein the controller is further configured to receive and communicate to the user the at least one of context dependent options and context dependent information.

15. The point and select infotainment system as recited in claim 14, wherein the at least one of context dependent options and context dependent information is an at least one context dependent option, and wherein the controller is further configured to, upon a user requesting one of the at least one context dependent option, receive and fulfill the requested option.

16. The point and select infotainment system as recited in claim 15, wherein the requested option is to provide information related to the at least one point of interest.

17. The point and select infotainment system as recited in claim 16, wherein the requested option is to update a second database with information related to the at least one point of interest.

18. The point and select infotainment system as recited in claim 17, wherein the requested option is to establish communication with the at least one point of interest.

19. A point and select method comprising:
capturing a pointing direction of a user;
obtaining geopositioning information;
communicating the pointing direction and the geopositioning information to a first database, the first database configured to analyze the pointing direction and the geopositioning information to arrive at at least one of context dependent options and context dependent information;
receiving and communicating to the user the at least one of context dependent options and context dependent information.

20. The point and select method as recited in claim 19, further comprising upon a user requesting one of the at least one context dependent options, receiving and fulfilling the requested option.
